(19) United States
(12) Patent Application Publication
(10) Pub. No.: US 2011/0256234 A1
(43) Pub. Date: Oct. 20, 2011

(54) CARRIER SYSTEM FOR SUBSEQUENT APPLICATION ONTO SUBSTRATES AND METHOD THEREFOR

(76) Inventors: Oliver Marte, Wattwil (CH); Martin Meyer, Thalwil (CH); Murray Height, Zurich (CH); Anita Bienz, Buetschwil (CH)

(21) Appl. No.: 13/057,877

(22) PCT Filed: Aug. 6, 2009
(86) PCT No.: PCT/CH2009/000268

§ 371 Date: Jul. 5, 2011

(30) Foreign Application Priority Data
Aug. 8, 2008 (CH) 1241/08

(51) Int. Cl. A01N 59/20; A01P 1/00; A01N 59/16; C09K 3/00; C08G 63/91

(52) U.S. Cl. 424/618; 252/182.28; 252/182.13; 252/182.17; 525/418; 424/630; 424/641

(57) ABSTRACT

A carrier system for transport of functional chemicals in substrates, such as fiber and plastic materials, comprises a carrier compound and at least one functional chemical, whereby the carrier compound consists of micelles, liposomes, lyotropic liquid crystals, or intercalation compounds. The functional chemical that is transported by the carrier compound migrates into the substrate and has an anisotropic distribution therein. Methods for modification, for activation and deactivation in a subsequent application on substrates are described.

The invention relates to a carrier system for subsequent application onto substrates according to claim 1 as well as a method with use of the carrier system according to claims 11, 14 and 20.

Synthetic fibers and plastics are basic materials for a wide variety of consumer goods. The range of use of the respective material is prescribed by the existing physical and chemical properties inherent to the material. Since the latter in many cases are not sufficient for achieving the purpose of the article manufactured therefrom, additional finishing processes must be carried out on the basic material.

A typical example is the dyeing of synthetic fibers for textiles. Here, water-insoluble dyes that are dispersed in aqueous medium are fixed thermally within the framework of a thermosol process [1], [2]. The nonpolar dyes that are adsorbed on the fiber surface are dissolved at 180-190° C. by the fiber polymer and are isotropically distributed based on the prevailing concentration gradient on the fiber cross-section.

The list below consolidates the documents based on which the prior art is subsequently explained:
[1] WO 2005/088004, Method for Optical Brightening of Synthetic Fibers or of Synthetic Fibers Mixed with Natural Fibers
[2] H. K. Rouette, Lexikon für Textilveredlung [Dictionary for Textile Finishing], Vol. 3, pp. 2197-2199, (1995) Laumann-Verlag Dülmen
[3] H. K. Rouette, Lexikon für Textilveredlung, Vol. 1, pp. 699-701, (1995) Laumann-Verlag Dülmen
[4] W. D. Schindler, P. J. Hauser, Chemical Finishing of Textiles, CRC Press (2004), pp. 87-96, Boca Raton, Boston, New York, Washington, D.C.
[5] DE 31 10 906 A1, Hydrophile Polymermasse [Hydrophilic Polymer Mass]
[6] G. Gruenwald, Plastics, C. Hanser Verlag Munich (1993), pp. 268-276
[7] WO 2006/084390 A1, Antimicrobial and Antifungal Powders Made by Flame Spray Pyrolysis

The production of the most widely varied application functions of fiber and plastic materials by a corresponding coating process is also common practice. Functional examples, which are to be produced by coating of materials: antistatic, bactericidal, hydrophilic, hydrophobic or flame-retardant properties in synthetic fibers. With respect to the standard, an application function that is typical of a specific application of the corresponding article is produced by coating fibers and plastics [3].

Within the framework of more recent developments, multifunctional coatings are applied on fiber and plastic materials that are attached depending on the material and its use with the most varied technologies. Examples in this respect are hydrophilic functional layers combined with bactericidal action or hydrophobically dominated coatings with antistatic function [4].

Significant disadvantages of all functionalities produced by coating or impregnation are their more or less limited washability, abrasion resistance and adhesion resistance. The performance that is typically limited for coatings is connected directly to the composition of the fiber or plastic surface. In addition to the surface characteristics that are typical of the fibers and plastics, there are chemicals that are adsorbed multiple times or that migrate from the polymer mass from an upstream process stage, which chemicals are responsible for the inadequate washability or adhesion resistance of a coating layer.

Another possibility that has already been in practice for a long time is the incorporation of functional materials in the extrusion mass, such as, e.g., chemicals, native and synthetic polymers, and particulate materials [5], [6]. In this connection, the functional materials are mixed and extruded with the polymer melts and are thus stored in the polymer in a largely wash-proof and abrasion-proof manner. Typical examples in this respect are chemical compounds that are used in UV protection, pigment dyes for dyeing, and recently tin and silver compounds as well as silver particles for achieving an antimicrobial action [7].

Significant disadvantages of a functionalization that is performed within the framework of the extrusion process are the only conditional market flexibility and the high production costs, which can be dropped only with high production amounts. The basically excessive amounts used of functional chemicals, since the compounds that are stored in the fiber core in many cases do not have functional effectiveness or can be mobilized only with difficulty, are another disadvantage.

Based on the above-mentioned disadvantages, the object of the invention is to provide a method that allows the substrate, subsequently isolated from the production process of the substrate or the fiber or plastic material, to be modified by means of functional chemicals.

A second object of the invention is to activate potential existing functions inherent in the substrate. These are functions that are still not manifested in terms of the desired effect after the extrusion process or are partially or completely lost because of a treatment of the substrate subsequent to the extrusion process.

A third object is to completely or partially deactivate existing and active functions inherent in the substrate.

The solution of these objects according to the invention is achieved by the production and application of carrier systems. In particular, these are micellar micro- or nanocontainers that have an affinity to the substrate or to the fiber material or polymer material and include the functional chemicals and/or contain the latter as structural elements of the carrier compound.

By definition, the carrier system consists of a carrier compound and a functional chemical that is to be transported. The term of functional chemical is defined as follows:

All ingredients that interact with the carrier compound and the substrate and that are based on the anisotropic distribution in the substrate are referred to as functional chemicals or active substances, and they are used for the production of the desired application function of the substrate.

In this way, it is possible to incorporate insoluble compounds (molecules, nanoparticles, etc.), such as, e.g., salts and compounds that contain polar amino, hydroxyl or carboxyl groups, into the polymer structure of the substrate.

The inverse application of incorporating into the substrate nonpolar compounds from the aqueous phase that are to be isotropically distributed into the substrate because of their solubility is prior art and is used as mentioned, for example, when dyeing textile fibers [2].

The functional chemical according to the invention is used in the production of a new function inherent in the fiber, which is introduced into the more or less nonpolar polymer material of the substrate and is fixed physically and/or chemically, if necessary. The functional chemicals are compounds that necessarily result in an anisotropic distribution in the fiber or plastic polymer in contrast to dyes because of their limited solubility in the fiber or plastic polymer. The transport of the functional chemical into the substrate is produced or accelerated with physical methods, whereby preferably thermal and mechanical (typically ultrasound) methods are used.

The application of functional chemicals containing carrier compounds is carried out independently of the extrusion process, preferably within the framework of a fiber- or plastic-finishing process.

The production of the carrier compounds containing the functional chemicals is carried out with low-molecular but also polymer compounds, which have the constitutional requirements to form inclusion compounds, micelle- or liposome- and/or liquid-crystalline structures, which form so-called ‘carrier compounds’ as part of the carrier system. In this case, the functional chemicals can themselves be present as a structural element of this carrier compound or, for example, solubilized in the compound as a guest compound.

Another feature of the carrier compounds is their amphiphilic nature or the possibility, by self-assembling, of orientation corresponding to the polarity of the continuous phase that encloses the carrier compound.

Another feature is their inconstancy, since both the orientation (e.g., inverse micellar formation) and the “crystalline form” (e.g., temperature-dependent mesophases) of the carrier compounds can change based on various parameters. In addition to the temperature, there are, for example, the concentration of the amphiphilic compound, the pH, and the ionic strength of the solution, which definitively determine the formation and the nature of the carrier compounds and thus the carrier system.

Typical vesicles, micelles or lyotropic liquid crystals forming compounds are surfactants in combination with a solvent (e.g., water). As surfactants, bipolar non-ionogenic, anionic and cationic compounds as well as mixtures of non-ionogenic and anionic or cationic compounds are used. The HLB values (hydrophilic, lipophilic balance) of the surfactants that are used in each case are between 0 and 20, corresponding to the polarity of the continuous phase. In the case of an oil-dominated continuous phase, surfactants with HLB values of between 0 and 12 and surfactants in water-dominated phases with HLB values of between 5 and 20 are used. Typical structural features of the surfactants that are used are their hydrocarbon chains with a length of C₃-C₂₄, preferably C₈-C₁₈, and their polar group that can have a cationic, anionic or non-ionogenic nature.

Above the critical concentration of the micelle formation (CMC), surfactants are able to solubilize substances and/or particles that are insoluble in the continuous phase. This also happens according to the invention with the polar substances that are dissolved for the time being in the aqueous continuous phase when, for example, a nonpolar continuous phase is produced during a dehydration process. In addition, a phase inversion can be produced, under certain circumstances associated with a multi-phase system.

Another compound class, suitable for forming carrier compounds, for incorporation of compounds or functional chemicals to be anisotropically distributed in the substrate are phase-transfer catalysts, such as, e.g., 1,4-diazabicyclo[2,2,2]-octane (DABCO), tetra-n-hexylammonium chloride or tetra-n-butylammonium bromide. The latter can be used both alone with the functional chemical and combined with surfactants and other compounds that have a solubilizing action.

Based on the polar components that are to be incorporated in the polymer material, in comparison to the substrate, additional components that promote solubilization, such as co-surfactants and/or compounds that are capable of intercalation (retention of molecules in chemical compounds), are used. The intercalation complexes that are produced by intercalation are also referred to as inclusion compounds or clathrates.

Alcohols with a chain length of C₃-C₁₂, primarily C₅-C₈, have proven their value as co-surfactants. Compounds according to the invention that contain ether, hydroxyl, carboxyl, amino and amide groups, in particular urea and derivatives thereof (e.g., biuret, or triuret) as well as crown ethers, are successfully used as substances that form inclusion compounds.

The selection of the components that are necessary for the formation of carrier compounds depends on various processing parameters and in particular on the functional chemical and the function that is thus to be achieved on the substrate and its properties (e.g., crystallinity, glass conversion temperature, etc.).

The application of the components that form the carrier system on the substrate is carried out by immersion, spraying, coating or splashing, followed by a thermal process, in the course of which the continuous phase (e.g., water) that prevails during the application is evaporated. Here, forced adsorption of the carrier compounds that transport the active substance takes place on the substrate, in the further course of which the carrier compounds or individual components of the carrier compounds are anisotropically taken up with the solubilized active substance from the substrate, primarily in the outer substrate layers.

By using an active substance with a functional group, such as hydroxyl, carboxyl, amino, amide, isocyanate, sulfide, epoxy, ester or ether, a reactive surface is produced on the substrate, and thus a new function is produced on the substrate. The functional group can be present individually or in a combination.

The functional chemicals that are required for an activation of an existing function inherent in the fiber are distinguished by a high water retention capacity, which is transported together with the functional chemical in the carrier compound into the substrate. The water that is transported into the substrate together with the functional chemical, in particular with hydratable, bipolar compounds, hydratable intercalation compounds or phase transfer catalysts, produces an activation of an antimicrobial and antimycotic effect, in particular an antimicrobial and antimycotic effect on existing metal particles and metal ions inherent in the fiber, such as Ag^{o}/Ag⁺, Cu^{o}/Cu²⁺, Zn^{o}/Zn²⁺, etc. The above-mentioned compounds can be present individually or in a combination.

By using a functional chemical with a complexing, immobilizing, protective group-inserting or solubility-reducing function, an existing active function that is inherent in the substrate can be completely or partially deactivated.

The major advantages of the functionalization of fiber and plastic surface layers that is achieved in this way are the high flexibility of the method, with which it can be reacted very quickly with altered market requirements, and the low production costs in comparison to the extrusion method. This process makes it possible to perform the functionalization of the fiber and plastic materials in combination with other finishing measures, with which no additional processing costs are produced, with the exception of chemical costs.

### EXAMPLE 1

### Production of a Reactive Substrate Surface or Polymer Surface

Polyester fibers (substrate) have no polymer-bonded reactive groups to fix functional chemicals covalently within the framework of a finishing process performed in textile finishing.

By the application of a carrier system with its components forming carrier compounds in combination with a functional chemical that is suitable for further chemical cross-linking and a subsequent thermal process, the substrate is modified. In this case, polymer-bonded reactive groups are generated for further reactions on the fiber surface of the substrate. For this purpose, an aqueous solution of 8.5 g/l of lauryl sulfate, 15.1 g/l of urea, and 6.3 g/l of caprylic acid is applied. The application of the solution that contains the functional chemical is carried out by spraying, which corresponds to a pick-up of 76% relative to the dry weight of the substrate. Then, a thermal process is carried out at 190° C. for 60 seconds to fix the functional chemicals, followed by a washing process at 60° C. to purify the polymer surface of excess chemicals.

The carrier compound is formed by the lauryl sulfate and the urea. The functional chemical caprylic acid is both bonded in the structure of the carrier compound and solubilized by urea as an inclusion compound in various mesophases. Because of the polymer-fixed carboxyl groups, the polyester material treated in this way exhibits an alkali retention capacity or an acid number of 1.7 mg of KOH/g of polymer.

By the polymer-bonded carboxyl groups that are produced on the fiber surface according to the invention, additional polymers that have, for example, a hydrophilizing action, such as e.g., carboxylated polysaccharides, can be chemically fixed covalently and washably with aziridine compounds.

In the method for modification of a substrate with a carrier system, the carrier compound is applied to the substrate with at least one functional chemical that can be fixed physically or chemically. Then, the functional chemical is fixed by a thermal process. As a result, a new function on the substrate surface is generated. The carrier system can also have multiple functional chemicals.

### EXAMPLE 2

### Activation of the Antimicrobial Effect of Polyester Fibers

To achieve antimicrobial effects on tissues, granulated polyethylene terephthalate is mixed with silver additives, especially with silver nanoparticles, and it is extruded to form fiber material. The fibers that have an antimicrobial action are subsequently processed to form tissue and then are dyed within the scope of a finishing process at 130° C. During the dyeing process, the silver additives that are located in the outer fiber area are extracted in an undesirable way, whereby with increasing loss in silver on the fiber surface, the antimicrobial action is also reduced or completely lost.

The activation of the antimicrobial action according to the invention takes place after the dyeing process. To this end, an aqueous solution of 7.2 g/l of Imbentin AG/124S/040, 4.5 g/l of tetra-n-butylammonium chloride, and 2.5 g/l of magnesium chloride is applied by means of an impregnation process on the substrate (pick-up 46%). Then, a thermal process is carried out at 180° C. for 30 seconds. The functional chemicals in this carrier system are tetra-n-butylammonium chloride and magnesium chloride, which accelerate the mobilization of the silver ions.

The subsequently performed bactericidal tests (Table 1) show that a complete activation of the antimicrobial effect could be implemented with the measures that are performed.

TABLE 1
Test results of the antimicrobial action of the tissue before and after
dyeing, after activation, and after 3 washing cycles at 60° C. in connection
with the activation

| | Bactericidal Text⁽¹⁾ | |
|---|---|---|
| Treatment | % Reduction | Specific Activity |
| Before Dyeing | ≧99.9 | ≧3 |
| After Dyeing | <68.4 | <0.5 |
| After Activation | ≧99.9 | ≧3 |
| Washed 3×, 60° C. | 99.84 | 2.8 |

⁽¹⁾Test Method: Japanese Industrial Standard JIS L 1902

In a more precise way, the test results show the activation or reactivation of the antimicrobial effect that is achieved by the treatment that is described.

In the method for activation of a substrate with a carrier system, the carrier system is applied with at least one function of conveying compounds to the substrate, where said function is inherent to the activation of an existing fiber. Then, the activation of the potentially existing function is accomplished by a thermal process. The carrier system can also have multiple conveying compounds or functional chemicals.

### EXAMPLE 3

### Partial Deactivation of an Antimicrobial Function

Antimicrobial effects are very often produced before extrusion by adding additives to the polymer mass such as silver chloride or silver-containing ion exchange resins. The release of silver based on the antimicrobial effect is carried out because of the solubility and separation of the silver salts that are used in aqueous media. The disadvantage of the thus produced substrates that have an antimicrobial action is the low washing fade resistance as a result of excessive solubility of the silver salts. A higher washability can be achieved by a partial deactivation, in this case by a stronger immobilization of the silver.

A polyamide tissue that contains approximately 200 ppm [mg/kg] of silver chloride is impregnated with an aqueous solution that contains 4.6 g/l of dodecyl sulfate, 1.3 g/l of octylpyrrolidone, and 5 g/l of potassium rhodanide. The pick-up is 52%, relative to the tissue dry weight. In connection with the float application, the drying and a heat treatment are carried out at 160° C. for 60 seconds. The characterization of the effectiveness of the treatment relative to the partial silver immobilization is carried out by washing tests at 60° C. (Table 2).

TABLE 2

| Washing | ppm | Silver Content ppm [g/kg] | | |
|---|---|---|---|---|
| Cycles | a) | Loss % | ppm b) | Loss % |
| 0 | 198.0 | 0.00 | 198.0 | 0.0 |
| 1 | 168.8 | 14.75 | 178.6 | 9.8 |
| 5 | 51.9 | 73.80 | 100.6 | 49.2 |
| 10 | 17.6 | 91.10 | 58.4 | 70.5 |
| 20 | 7.5 | 96.20 | 30.5 | 84.6 |

Silver losses after several washing cycles of:
a) the tissue produced only antimicrobially, and
b) the tissue that is produced antimicrobially and is subsequently treated with a solution that has a deactivating action.

The values of Table 2 show that in the case of the tissue (a) that is produced only antimicrobially, after 10 washing cycles at 60° C., over 95% of the silver that has an antimicrobial action was washed out, with which also the antimicrobial effect no longer satisfies the requirements. The tissue that was subsequently treated with the silver-immobilizing solution (b) still shows a very high antimicrobial action with a residual silver content of 30.5 ppm after 20 washing cycles.

The results that are achieved demonstrate the effect of a partial deactivation of the very high, but non-wash-resistant antimicrobial effect. The result of the subsequent treatment is based on a partial silver immobilization, which results by the incorporation of potassium rhodanide in the fiber material in connection with the carrier compounds.

In the method for deactivating a substrate with a carrier system, the carrier system is applied to the substrate with at least one compound that promotes the function inherent to the deactivation of an existing fiber. Then, the partial deactivation of the potentially existing function is accomplished by a thermal process. The carrier system can also have multiple conveying compounds or functional chemicals.

1. Carrier system for transport of functional chemicals in a substrate, characterized in that the carrier system contains a carrier compound and at least one functional chemical and in that the functional chemical that is transported by the carrier compound migrates into the substrate and has an anisotropic distribution in the substrate.

2. Carrier system according to claim 1, wherein the carrier compound has a substrate affinity based on one or more components.

3. Carrier system according to claim 1 or 2, wherein the carrier compound consists of micelles, liposomes, lyotropic liquid crystals, or intercalation compounds.

4. Carrier system according to one of claims 1-3, wherein the carrier compound contains the functional chemical as a guest compound in solubilized form.

5. Carrier system according to one of claims 1-3, wherein the functional chemical itself forms a structural element of the carrier compound.

6. Carrier system according to one of claims 1-5, wherein the carrier compound contains a non-ionic, anionic or cationic surfactant.

7. Carrier system according to one of claims 1-6, wherein the carrier compound contains a mixture that consists of an anionic and non-ionogenic compound or a cationic and non-ionogenic compound.

8. Carrier system according to one of claims 1-7, wherein the carrier compound contains a mixture that consists of a surfactant and a co-surfactant, whereby the co-surfactants have a chain length of C₃-C₁₂, preferably C₅-C₈.

9. Carrier system according to one of claims 1-8, wherein the carrier compound contains phase-transfer catalysts such as 1,4-diazabicyclo[2,2,2]-octane (DABCO), tetra-n-hexylammonium chloride and tetra-n-butylammonium bromide or crown ether.

10. Carrier system according to one of claims 1-9, wherein the carrier compound contains inclusion compounds, in particular urea, urea derivatives or crown ether.

11. Method for modification of a substrate with a carrier system according to one of claims 1-10, wherein the carrier system with at least one functional chemical that can be fixed physically or chemically is applied to the substrate and wherein the functional chemical is fixed by a thermal process, and wherein a new function is generated on the substrate surface.

12. Method according to claim 11, wherein the functional chemical is anisotropically distributed in the substrate, preferably in an outer fiber layer, and is fixed there.

13. Method according to claim 11 or 12, wherein the functional chemical contains at least one functional group such as hydroxyl, carboxyl, amino, amide, isocyanate, sulfide, epoxy, ester or ether, and as a result, a reactive surface is produced on the substrate.

14. Method for activation of a substrate with a carrier system according to one of claims 1-10, wherein the carrier system is applied with at least one function of conveying compounds to the substrate, where said function is inherent to the activation of an existing fiber and wherein the activation of the potentially existing function is accomplished by a thermal process.

15. Method according to claim 14, wherein the functional chemical retains water and as a result, water is transported into the substrate, by which the activation is produced together with the functional chemical.

16. Method according to claim 14 or 15, wherein as a functional chemical, a hydratable bipolar compound, a hydratable intercalation compound, a phase-transfer catalyst or a combination thereof is used.

17. Method according to one of claims 14-16, wherein an antimicrobial and/or an antimycotic effect is activated by the application of a functional chemical.

18. Method according to claim 17, wherein the antimicrobial and/or antimycotic effect of existing metal particles and/or metal ions inherent in the substrate is activated.

19. Method according to claim 18, wherein silver, copper, zinc and salts thereof are used as metal particles and/or metal ions.

20. Method for deactivation of a substrate with a carrier system according to one of claims 1-10, wherein the carrier system is applied to the substrate with at least one compound that produces the deactivation of a function inherent to an existing fiber and wherein the deactivation of the active function is completely or partially accomplished by a thermal process.

21. Method according to claim 20, wherein the existing and active effect inherent in the substrate is completely or partially deactivated by means of the functional chemical for complexing, immobilization, by inserting a protective group, or by reducing the solubility.
